(19) United States
(12) Patent Application Publication
(10) Pub. No.: US 2014/0335384 A1
(43) Pub. Date: Nov. 13, 2014

(54) BATTERY, MOTOR VEHICLE AND METHOD FOR OPERATING THE BATTERY

(71) Applicants: Robert Bosch GmbH, Stuttgart (DE); Samsung SDI Co., Ltd., Yongin-si, Gyeonggi-do (KR)

(72) Inventors: Markus Kohlberger, Stuttgart (DE); Joachim Fetzer, Bad-Ditzenbach (DE); Holger Fink, Stuttgart (DE)

(21) Appl. No.: 14/363,721

(22) PCT Filed: Nov. 15, 2012
(86) PCT No.: PCT/EP2012/072684

§ 371 Date: Jun. 6, 2014

(30) Foreign Application Priority Data
Dec. 13, 2011 (DE) 10 2011 088 349.5

(51) Int. Cl. H01M 10/42; H01M 2/34

(52) U.S. Cl. CPC H01M 10/4257; H01M 2/347; H01M 2200/00; H01M 2220/20
USPC 429/50; 429/61

(57) ABSTRACT

A battery includes a battery cell, and an electrode of the battery cell is connected to the battery cell housing in an electrically conducting manner by a switching element. The battery also includes a monitoring circuit, which is configured to respond to detection of an interference signal by opening the switching element. The switching element is closed during operation without interference.

The present invention relates to a battery having a battery cell and also a motor vehicle having the battery in accordance with the invention. In addition, a method is provided for disconnecting an electrically conductive connection between an electrode and a battery cell housing of a battery cell.

### PRIOR ART

In motor vehicles that are at least in part driven electrically, electrical energy storage devices are used in order to store electrical energy for the electric motor that supports the drive or rather is used as the drive. In the latest generation of vehicles, so called lithium ion batteries are used for this purpose. Said lithium ion batteries are characterized inter alia by virtue of high energy densities and an extremely low self-discharge. Lithium ion cells have at least one positive and one negative electrode (cathode or rather anode) that can reversibly store (intercalation) or output (deintercalation) lithium ions (Li+).

FIG. 1 illustrates how individual battery cells 10 by way of example having a metallic battery cell housing 16 can be combined to form battery modules 12 and then to form batteries 14. This is achieved by means of a parallel or series connection (not illustrated) to the poles 18 of the battery cells 10. In this case, by definition, a battery module 12 or rather a battery 14 comprises at least two battery cells 10, wherein the terms battery 14 and battery module 12 are often used synonymously. The electrical voltage of a battery 14 amounts by way of example to between 120 and 600 volts of direct current.

In the case of so-called hard case cells, whose battery cell housing is embodied from a firm aluminum or steel sheet, one of the two electrodes is typically directly connected to the battery cell housing in order to avoid additional potential differences that can lead in the long term to corrosion of the battery cell housing. The other electrode is electrically disconnected from the battery cell housing by means of a seal.

The insulation between the battery cells can be damaged in the event of a malfunction, for example as a result of mechanical influences in the case of an accident involving a battery operated vehicle. The fact that one of the electrodes is connected to the battery cell housing in this case represents a safety risk.

DE 197 14 847 A1 discloses a circuit and a method for connecting a negative electrode of a battery cell to the battery cell housing. A resistor is provided between the negative electrode and the cell housing and said resistor is monitored by means of a sensor. In the case of unintentional contact of the positive electrode with the cell housing, the current flow is limited by means of the resistor and a signal is generated by the sensor.

### Disclosure of the Invention

A battery having a battery cell is provided in accordance with the invention. A characterizing feature is that an electrode of the battery cell is connected in an electrically conductive manner by way of a switching means to the battery cell housing that is for example embodied from aluminum or steel. In addition to this electrically conductive connection, the electrodes are only connected to the battery cell housing by way of the electrolytes, otherwise, in particular in the region of the feedthrough of the electrodes through the battery cell housing, said electrodes are electrically insulated from said battery cell housing. In addition, the battery comprises a monitoring circuit that is embodied for the purpose of opening the switching means in the case of detecting a malfunction signal, said switching means being closed during normal operation. Any signal that meaningfully indicates a disconnection of the electrodes from the battery cell housing is fundamentally suitable as a malfunction signal—by way of example signals that indicate an accident or any other case of damage.

The battery in accordance with the invention has the advantage that during normal operation, it is ensured that the battery cell housing is protected against corrosion. In the case of a malfunction, by way of example in the case of an accident involving a vehicle that is operated with a battery in accordance with the invention, the electrically conductive connection between the electrode and the battery cell housing is disconnected, whereby the battery cell housing is only connected to the electrodes by way of the electrolytes. In the case of a malfunction, the risk of a short circuit is reduced as a result of the battery cell housing being disconnected from the electrode.

In accordance with a preferred embodiment of the invention, the monitoring circuit is integrated into a battery cell monitoring circuit board. A battery cell monitoring circuit board is responsible for monitoring multiple battery cells within a battery and in the case of battery cells in the accordance with the prior art is also installed within the battery. Said battery cell monitoring circuit board normally monitors the voltages of multiple battery cells and furthermore said battery cell monitoring circuit board is provided with temperature sensors. Existing resources can be augmented by virtue of integrating the electronic monitoring circuit into the battery cell monitoring circuit board instead of installing an additional circuit board. It is likewise feasible that the battery cell monitoring circuit board already includes all required functions and means of the monitoring circuit, whereby the existing battery cell monitoring circuit board can be utilized. In addition, it is also possible in an advantageous manner to arrange the switching means on the battery cell monitoring circuit board in order to achieve an even more compact arrangement.

Another alternative in relation to the arrangement of the switching means is preferably to arrange said switching means in the battery cell, whereby each battery cell forms a unit with the switching means that is allocated to it.

The switching means can advantageously be a relay or a semiconductor component, by way of example a transistor, whereby further advantages can arise according to the respective conditions.

In the case of a parallel connection of multiple battery cells, the electrodes and the battery cell housing of the parallel-connected battery cells can preferably be connected in an electrically conductive manner by way of a common switching means. As a consequence, only one individual switching means is required for the parallel-connected battery cells.

It is preferred that the malfunction signal originates from a shock sensor. Said sensor detects shock of a battery operated vehicle in a very early deformation phase. Sensors of this type were hitherto used for the purpose of triggering restraining systems such as by way of example airbags or seat belt tensioners. By virtue of generating the malfunction signal in a very early accident phase, there is still sufficient time to disconnect the electrode from the battery cell housing. As a consequence, it is ensured that the switching means can still be opened by way of example before the monitoring circuit is destroyed as a result of the accident.

It is preferred that the battery is a lithium ion battery. Particularly high energy densities can be achieved as a result of using lithium ion technology, which leads to further advantages particularly in the electromobility industry.

In addition, a motor vehicle that comprises a battery in accordance with the invention is provided. The battery is generally provided for the purpose of supplying energy to an electrical drive system of the vehicle.

Furthermore, a method is provided for disconnecting an electrically conductive connection between an electrode and a battery cell housing of a battery. Said method comprises a first step of providing a battery in accordance with the invention and a second step of detecting a malfunction signal by means of the monitoring circuit. In the third step, the switching means between the electrode and the battery cell housing is opened.

Advantageous embodiments of the invention are disclosed in the dependent claims and are evident in the description.

### DRAWINGS

Exemplary embodiments of the invention are further explained with reference to the drawings and the description hereinunder. In the drawings:

FIG. 1 illustrates a battery cell, a module and a battery, and

FIG. 2 illustrates a battery cell in accordance with the invention having a switching means.

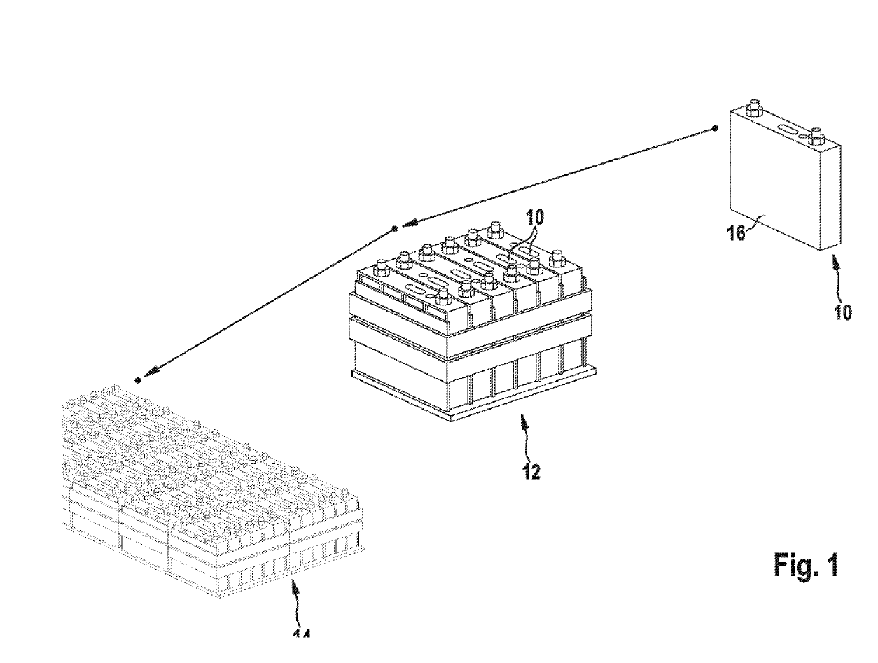

FIG. 1 has already been mentioned for the purpose of explaining the prior art.

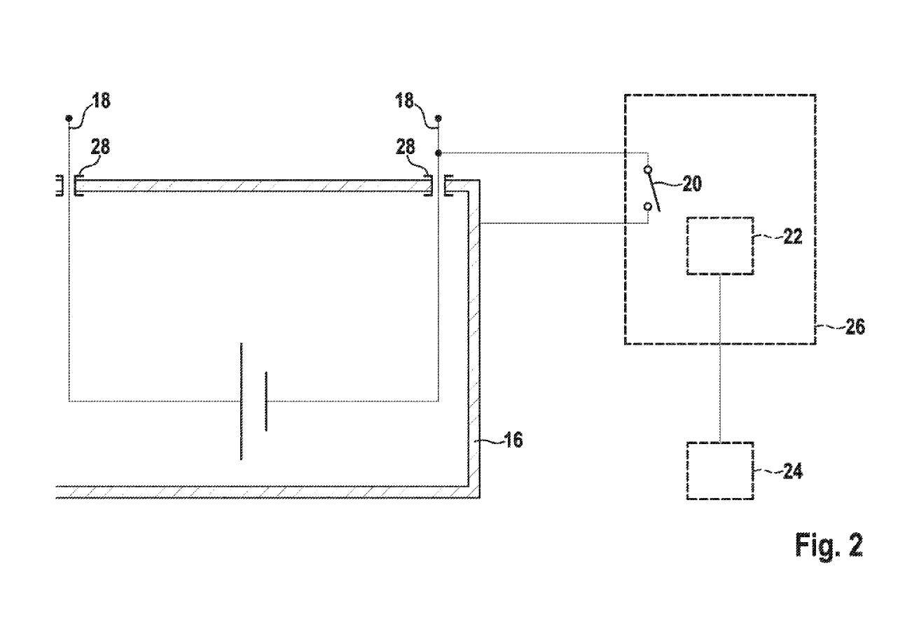

FIG. 2 illustrates a part region of the battery 14 in accordance with the invention, said part region comprising a battery cell 10. Normally the negative of the two galvanic electrodes 18 is connected in an electrically conductive manner to the battery cell housing 16 by way of the switching means 20. In addition to this connection by way of the switching means 20, the electrodes 18 are only connected to the battery cell housing 16 by way of the electrolytes. The electrodes 18 are disconnected from the battery cell housing 16 by means of an electrical insulator 28 in the region of the feedthrough of the electrodes 18 through the battery cell housing 16. The outline (bold dashed line) of the monitoring circuit 22, the battery cell monitoring circuit board 26 and also the shock sensor 24 are schematically illustrated in FIG. 2. As is illustrated, the switching means 20 can be arranged together with the monitoring circuit 22 on the battery cell monitoring circuit 26 or said switching means can be a part of said battery cell monitoring circuit, wherein the monitoring circuit 22 is connected by way of example to a shock sensor 24. As a rule, more than one of the battery cells 10 are housed in a single battery 14, in particular in the housing of the battery 14. In cases such as these, a monitoring circuit 22 controls multiple switching means 20. This monitoring circuit 22 and the switching means 20 can in turn be arranged together on a battery cell monitoring circuit board 26 that is likewise situated in the battery housing. A standard existing shock sensor 24 can be used as a shock sensor 24 and said shock sensor as a rule is fastened outside of the battery 14 to the vehicle bodywork.

During normal operation, the switching means 20 is closed so that the negative electrode 18 is connected in an electrically conductive manner to the battery cell housing 16. If the monitoring circuit 22 detects a malfunction signal that originates from the shock sensor 24, then the monitoring circuit 22 opens the switching means 20. As a consequence, the electrically conductive connection between the negative electrode 18 and the battery cell housing 16 is disconnected.

1. A battery, comprising:
a battery cell having an electrode, the electrode of the battery cell connected in an electrically conductive manner to the a battery cell housing by way of a switching element; and
a monitoring circuit configured to open the switching element upon in the case of detecting a malfunction signal, said switching element configured to remain closed during normal operation.

2. The battery as claimed in claim 1, wherein the monitoring circuit is integrated into the a battery cell monitoring circuit board.

3. The battery as claimed in any one of the preceding claims claim , wherein the switching element is arranged on the a battery cell monitoring circuit board.

4. The battery as claimed in claim 1, wherein the switching element is arranged in the battery cell.

5. The battery as claimed in any one of the preceding claims claim 1, wherein the switching element is a relay.

6. The battery as claimed in claim 1, wherein the switching element is a semiconductor component.

7. The battery as claimed in claim 1, wherein the malfunction signal originates from a shock sensor.

8. The battery as claimed in any one of the preceding claims claim 1, wherein: the battery includes multiple battery cells in parallel connection, and
the electrodes of said multiple battery cells and the battery cell housing are connected to one another in an electrically conductive manner by a common switching element.

9. A motor vehicle, comprising:
a battery including:
a battery cell having an electrode, the electrode of the battery cell connected in an electrically conductive manner to a battery cell housing by a switching element; and
a monitoring circuit configured to open the switching element upon detecting a malfunction signal, said switching element configured to remain closed during normal operation.

10. A method for disconnecting an electrically conductive connection between an electrode and a battery cell housing of a battery cell, the method comprising:
(i) providing a battery having a battery cell and a monitoring circuit, the battery cell including an electrode that is connected in an electrically conductive manner to a battery cell housing by a switching element, the monitoring circuit configured to open the switching element upon detecting a malfunction signal, the switching element configured to remain closed during normal operation;
(ii) detecting a malfunction signal by means of via the monitoring circuit: and
(iii) opening the switching element between the electrode and the battery cell housing.
